(19) United States
(12) Patent Application Publication
(10) Pub. No.: US 2026/0084240 A1
(43) Pub. Date: Mar. 26, 2026

(54) LASER ASSISTED BONDING DEVICE AND METHOD FOR LARGE AREA BONDING

(71) Applicant: STATS ChipPAC Pte. Ltd., Singapore (SG)

(72) Inventors: JongChan PARK, Incheon (KR); ChungLyul AHN, Incheon (KR); TaeKeun LEE, Incheon (KR)

(21) Appl. No.: 19/286,285

(22) Filed: Jul. 31, 2025

(30) Foreign Application Priority Data
Sep. 25, 2024 (CN) 202411343855.4

(51) Int. Cl. B23K 26/08; B23K 26/06; B23K 26/073; B23K 26/24; B23K 101/36

(52) U.S. Cl. CPC B23K 26/0869; B23K 26/0626; B23K 26/073; B23K 26/24; B23K 2101/36

(57) ABSTRACT

A laser assisted bonding device includes: a laser emitter array having a plurality of laser emitter units, wherein each of the laser emitter units is operable to be turned on or off independently from the other laser emitter units such that the laser emitter array is capable of emitting a laser beam with a controllable beam shape; a carrier for placing a substrate which an electronic component is disposed on and to be bonded onto via a solder material; a transfer mechanism for moving the laser emitter array relative to the carrier; and a controller electronically coupled to the transfer mechanism to control a movement of the laser emitter array relative to the carrier, and electronically coupled to the laser emitter array to irradiate the laser beam to the substrate with a controllable power profile for the solder material when the electronic component is bonded onto the substrate.

### TECHNICAL FIELD

The present application generally relates to semiconductor technology, and more particularly, to a laser assisted bonding device and method for large area bonding.

### BACKGROUND OF THE INVENTION

Laser assisted bonding or soldering processes have been used to replace conventional massive reflowing processes in forming semiconductor packages, because during the laser assisted soldering process thermal stresses within the semiconductor packages can be reduced.

However, small laser tools such as handheld laser devices are used to implement the assisted bonding or soldering processes, which can only generate laser beams with a size of around 25*25 mm² to 65*65 mm² or even smaller. These small tools can only focus on local areas of objects such as semiconductor chips or packages, and cannot cover a large object such as a 12 inch wafer. Further, if the laser beam is enlarged by increasing a working distance from the laser device to the object or by using an optical system, a power density of the laser beam would be decreased significantly and thus may not meet the power requirement for bonding.

Therefore, a need exists for a laser assisted bonding device and method which can be used for bonding of large area objects efficiently.

### SUMMARY OF THE INVENTION

An objective of the present application is to provide a laser assisted bonding device and method which can be used for bonding of large area objects efficiently.

According to an aspect of the present application, a laser assisted bonding device is provided. The laser assisted bonding device comprises: a laser emitter array having a plurality of laser emitter units, wherein each of the laser emitter units is operable to be turned on or off independently from the other laser emitter units such that the laser emitter array is capable of emitting a laser beam with a controllable beam shape; a carrier for placing a substrate which an electronic component is disposed on and to be bonded onto via a solder material; a transfer mechanism for moving the laser emitter array relative to the carrier; and a controller electronically coupled to the transfer mechanism to control a movement of the laser emitter array relative to the carrier, and electronically coupled to the laser emitter array to irradiate the laser beam to the substrate with a controllable power profile for the solder material when the electronic component is bonded onto the substrate via the solder material.

In another aspect of the present application, a laser assisted bonding method is provided. The method comprises: placing a substrate on a carrier, wherein an electronic component is disposed on the substrate and to be bonded onto the substrate via a solder material; irradiating to the carrier a laser beam with a controllable beam shape from a laser emitter array having a plurality of laser emitter units, wherein each of the laser emitter units is operable to be turned on or off independently from the other laser emitter units; and moving the laser emitter array relative to the carrier such that the laser beam is irradiated to the substrate with a controllable power profile for the solder material when the electronic component is bonded onto the substrate via the solder material.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain the principles of the invention.

### BRIEF DESCRIPTION OF DRAWINGS

The drawings referenced herein form a part of the specification. Features shown in the drawing illustrate only some embodiments of the application, and not of all embodiments of the application, unless the detailed description explicitly indicates otherwise, and readers of the specification should not make implications to the contrary.

FIGS. 1a and 1b illustrate a laser assisted bonding device according to an embodiment of the present application.

FIG. 2 illustrates an exemplary partial layout of an array of VcSEL units according to an embodiment of the present application.

FIGS. 3a to 3c illustrate three power profiles received by an object in different situations according to an example of the present application.

FIG. 4 illustrates a temperature measurement result of a laser beam emitted by a laser bonding device according to an embodiment of the present application.

FIGS. 5a to 5e illustrate a bonding process implemented by a laser assisted bonding device according to an embodiment of the present application.

The same reference numbers will be used throughout the drawings to refer to the same or like parts.

### DETAILED DESCRIPTION OF THE INVENTION

The following detailed description of exemplary embodiments of the application refers to the accompanying drawings that form a part of the description. The drawings illustrate specific exemplary embodiments in which the application may be practiced. The detailed description, including the drawings, describes these embodiments in sufficient detail to enable those skilled in the art to practice the application. Those skilled in the art may further utilize other embodiments of the application, and make logical, mechanical, and other changes without departing from the spirit or scope of the application. Readers of the following detailed description should, therefore, not interpret the description in a limiting sense, and only the appended claims define the scope of the embodiment of the application.

In this application, the use of the singular includes the plural unless specifically stated otherwise. In this application, the use of “or” means “and/or” unless stated otherwise. Furthermore, the use of the term “including” as well as other forms such as “includes” and “included” is not limiting. In addition, terms such as “element” or “component” encompass both elements and components including one unit, and elements and components that include more than one subunit, unless specifically stated otherwise. Additionally, the section headings used herein are for organizational purposes only, and are not to be construed as limiting the subject matter described.

As used herein, spatially relative terms, such as “beneath”, “below”, “above”, “over”, “on”, “upper”, “lower”, “left”, “right”, “vertical”, “horizontal”, “side” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. It should be understood that when an element is referred to as being “connected to” or “coupled to” another element, it may be directly connected to or coupled to the other element, or intervening elements may be present.

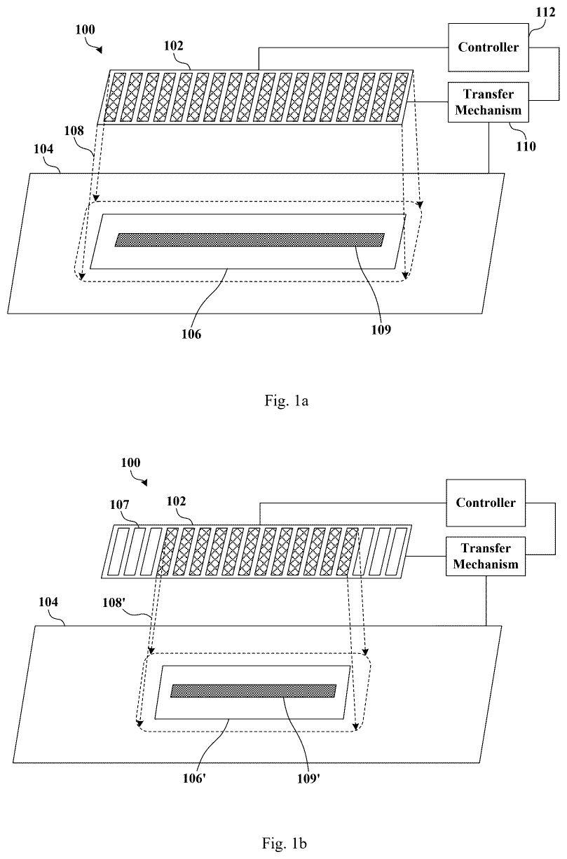

FIG. 1a illustrates a laser assisted bonding device 100 according to an embodiment of the present application. The laser assisted bonding device 100 can generate a laser beam which may be used to bond one or more electronic components such as semiconductor chips onto a substrate such as a printed circuit board, an interposer, etc. by heating a solder material between the electronic components and the substrate. In particular, the solder material may be deposited onto either or both of the electronic components and the substrate prior to the bonding process, and then during the bonding process the solder material may be melted by energy delivered by the laser beam and later solidify as solder bumps to bond the electronic components with the substrate.

As shown in FIG. 1a, the laser assisted bonding device 100 includes a laser emitter array 102 which is movably positioned above a carrier 104. The carrier 104 may be a platform where a substrate 106 is placed. Before the bonding process, one or more electronic components (not shown) may be disposed on the substrate 106 via a solder material (not shown), so as to be bonded onto the substrate 106 after the bonding process. The laser emitter array 102 has a plurality of laser emitter units such as vertical cavity surface emitting laser (VcSEL) units, edge emitting laser (EEL) units, or any other suitable laser emitter units. In a preferred embodiment, the laser emitter array 102 may be consisting of VcSEL units, which can generate a laser light having an excellent straightness and a high energy level. It is easy to control the operation of the laser emitter array 102 as the laser emitter units are generally independently controlled. The laser emitter units may be arranged in rows and columns at regular intervals, and the number, spacing and type of the laser emitter units can be configured based on actual needs on the bonding process. In the embodiment shown in FIG. 1a, the laser emitter units are further grouped into several columns, each of which can be turned on or off together. As such, a two-level control mechanism can be applied to the laser emitter array 102, i.e., a first level of units (the laser emitter units can be turned on or off independently) and a second level of columns (the laser emitter units in each column can be turned on or off together but independently from the other columns). It can be appreciated that the grouping of the laser emitter units may be on a row basis, or on a sector or region basis (i.e., two or more rows which are adjacent to each other).

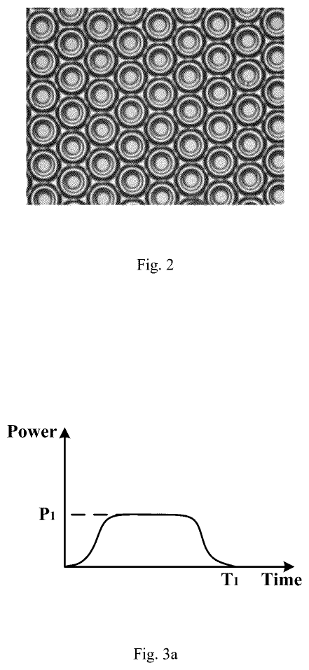

FIG. 2 illustrates an exemplary partial layout of an array of VcSEL units according to an embodiment of the present application. Each of the VcSEL units is operable to be turned on or off independently from the other VcSEL units. As such, the laser emitter array consisting of the array of VcSEL units is capable of emitting a laser beam with a controllable beam shape by turning on or off a portion of the VcSEL units.

For example, FIG. 1b illustrates the laser assisted bonding device shown in FIG. 1a which is operating in a different configuration from the configuration shown in FIG. 1a. As shown in FIG. 1b, since a smaller substrate 106′ is placed on the carrier 104 for further processing, a portion of the laser emitter units which are positioned at a peripheral region 107 of the laser emitter array 102 may be turned off to reduce an area or section of the laser beam 108′ when it reaches the substrate 106′ on the carrier 104. In the example, the laser beam 108′ with the reduced area can still cover the entire substrate 106′ such that the substrate 106′ can receive the laser energy delivered by the laser beam 108′ efficiently which further facilitates the bonding process. In some embodiments, the laser beam 108′ may have a shape substantially the same as that of the substrate 106′, but have a width equal to or greater than (e.g., 1.1 to 1.5 times of) that of the substrate 106′ and a length equal to or greater than (e.g., 1.1 to 1.5 times of) that of the substrate 106′ when it reaches the substrate 106′. In that case, only a little portion of the laser energy may be emitted to a region of the carrier 104 which is not covered by the substrate 106′, thereby reducing undesired waste of the laser energy.

It can be appreciated that although in the embodiment shown in FIGS. 1a and 1b the laser emitter array 102 has a rectangular shape, the laser beam 108 emitted from the laser emitter array 102 may not have the same shape when it reaches an object such as the substrate. For example, a portion of the laser emitter units can be turned off to form a laser beam having a bar shape or any other desired shapes, depending on a shape of the substrate, or particular a size of the substrate to be covered. It is assumed in these embodiments that electronic component(s) to be bonded onto the substrate has substantially the same or similar shape or size as that of the substrate, and the solder material is substantially distributed across an entire width or length of the substrate. If the solder material is not substantially distributed across an entire width or length of the substrate but is deposited on a portion of the width or length of the substrate, a laser beam to cover the substrate may refer to that the laser beam can at least cover the width or length of the pattern of the solder material for heating or bonding purpose.

Still referring to FIG. 1a, it can be appreciated that a working distance from the laser emitter array 102 to the carrier 104 or to the substrate 106 may be small, for example, less than 10 cm, or preferably between 1 to 10 cm or more preferably around 6 cm. As such, a shape and size of the laser beam 108 may be substantially dependent on a divergence angle of the laser light emitted by each laser emitter unit and the working distance from the laser emitter array to the object. In particular, an appropriate working distance can not only provide for a desired coverage of the laser beam but also avoid distorting the stability of the laser beam. In that case, the coverage of the laser beam, i.e., the irradiated area of the laser beam when it reaches the substrate, can be adjusted by turning on or off a portion of the laser emitter units. Also, the appropriate working distance can realize precise alignment between the laser beam 108 and the substrate 106 by solely adjusting their relative position. Also, no optical system such as an optical lens or optical fiber or cable is needed for the laser emitter array 102 as the laser beam 108 can cover entirely the substrate 106 or the electronic component thereon. Without the optical system, the laser energy from the laser emitter array 102 can be utilized more efficiently because there is no loss of laser energy during light transmission in the optical system.

As aforementioned, the laser emitter units may emit laser lights at a divergence angle, which may be within a certain range. In some embodiments, the divergence angle may be smaller than 10 degrees or preferably smaller than 5 degrees. In that case, the laser lights emitted by the laser emitter units may overlay on the surface of the substrate to form the laser beam with a light distribution pattern. As shown in FIG. 1a, the light beam 108 forms a maximum laser power area 109 generally in the center of the laser distribution pattern on the substrate 106, which may have a highest laser intensity than the other areas of the laser distribution pattern. Similarly, as shown in FIG. 1b, the light beam 108′ forms a maximum laser power area 109′ generally in the center of the laser distribution pattern on the substrate 106′. It can be appreciated that the maximum laser power area may extend along a row direction of the laser emitter array and is positively associated with the columns of laser emitter units that are turned on. As the intensity or power of the laser beam is maximum in the maximum laser power area, it is preferred to align the substrate 106 with the maximum laser power area or scan the substrate 106 with the maximum laser power area to improve utilization of the laser power.

In some embodiments, the maximum laser power area may have an average laser power which is at least 1.2 to 5 times (preferably 2 to 5 times) or even higher than that of the remaining area irradiated by the laser beam. In some embodiments, the maximum laser power area may have a width that is less than 50% (preferably less than 20%, and more preferably less than 10%) of the entire area irradiated by the laser beam.

In some embodiments, the laser emitter array 102 may have various configuration to form the maximum laser power area. For example, the laser emitter units in the center of the laser emitter array 102 may have a greater power than (e.g., greater than 1.5 times, or preferably greater than 2 times, or more preferably greater than 3 times) the other laser emitter units in the peripheral region of the laser emitter array 102. In another example, the laser emitter array 102 may be formed on a curved base, to orientate the laser light emitted by each of the laser emitter units in a desired direction. In other words, the maximum laser power area may be at or around a “focus” of the curved laser emitter array 102. For example, the curved base may have an arc-shaped cross section, with its central laser emitter units substantially perpendicular to the carrier 104 and its peripheral laser emitter units inclined to the carrier 104. In some other examples, only a central region (e.g., occupying less than 50% of the entire area) of the curved base may be arc-shaped, and the other regions of the curved base may be flat. In some other embodiments, the laser emitter array 102 may be formed on a flat base, but each of the laser emitter units may be individually orientated with respect to the carrier 104.

The laser assisted bonding device 100 further includes a transfer mechanism 110, which may be mechanically coupled to the laser emitter array 102 and/or the carrier 104. The transfer mechanism 110 can move the laser emitter array 102 relative to the carrier 104 by moving one or both of the laser emitter array 102 and the carrier 104. For example, the transfer mechanism 110 may include an actuator such as a robotic arm which is mechanically coupled to the laser emitter array 102. The actuator can, for example, move the laser emitter array 102 vertically towards or away from a plane of the carrier 104 to change the working distance from the laser emitter array 102 to the carrier 104, and/or moves the laser emitter array 102 horizontally along the carrier 104 to align the laser emitter array 102 with the carrier 104 or with the substrate 108 thereon. In another example, the transfer mechanism 110 may be a conveyor such as a conveyor belt, which can support the carrier 104 and move it horizontally relative to the laser emitter array 102. In a preferred embodiment, the transfer mechanism 110 may be only mechanically coupled to the laser emitter array 102, i.e., the carrier 104 may be stationary during the bonding process especially when the laser beam is emitted from the laser emitter array 102, so as to avoid vibration or any other undesired movement of the carrier and the substrate thereon.

Furthermore, the laser assisted bonding device 100 also includes a controller 112 which can be a micro controller (MCU) or any other suitable signal or data processing units. The controller 112 can be electrically coupled to the laser emitter array 102 and the transfer mechanism 110. In particular, the controller 112 can control the operation of the transfer mechanism 110 by receiving a user's input or automatically based on a preset algorithm, so as to control a movement of the laser emitter array 102 relative to the carrier 104. The controller 112 may also send control signals to the laser emitter array 102 to control the operation such as the on/off state of the individual laser emitter units, such that the laser beam 108 irradiated to the substrate 102 can have a controllable power profile for the solder material on the substrate 102 when the electronic component is bonded onto the substrate 106 via the solder material.

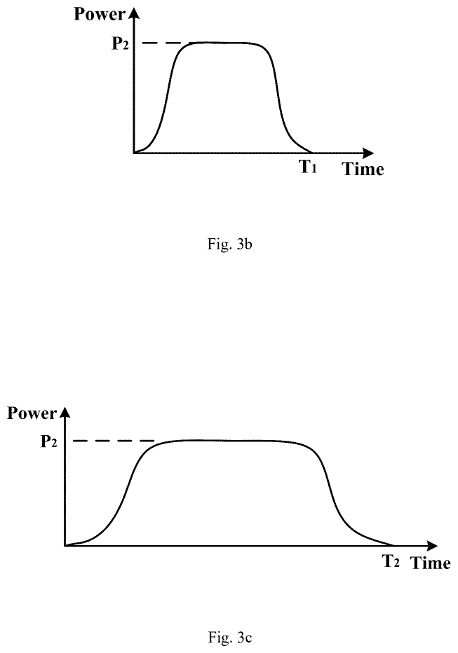

FIGS. 3a to 3c illustrate three power profiles received by an object in different situations according to an example of the present application. In the different situations, a speed and/or a laser power of the laser emitter array may change, depending on the actual needs of the laser assisted bonding.

In particular, as shown in FIG. 3a, the laser emitter array may move at a speed V₁ relative to the carrier, and the laser emitter array may be operating at a certain laser power P. Accordingly, it may take a period T₁ to move the laser emitter array across the carrier, which results in a power peak P₁ at the carrier or at the substrate placed thereon. It can be seen that before and after the power received by the object is maintained at the peak P₁, there are a power rising period and a power falling period for the substrate because it may take some time to align the substrate or a certain region of the substrate with the maximum laser power area produced by the laser beam. As such, the power profile can mimic the reflow heating profile for the solder material as desired.

As shown in FIG. 3b, the laser emitter array may move at the speed V₁ relative to the carrier, but the laser emitter array may be operating at another laser power P′ which is about two times of the laser power P as described with respect to FIG. 3a. Accordingly, it may take the same period T₁ to move the laser emitter array across the carrier, which results in a power peak P₂ which is two times of the power peak P₁ at the carrier because the laser power P′ emitted by the laser emitter array is higher.

Further, as shown in FIG. 3c, the laser emitter array may move at a speed V₂ relative to the carrier, which is a half of the speed V₁. At the same time, the laser emitter array may be operating at the laser power P′. Accordingly, it may take a period T₂ which is two times of the period T₁ to move the laser emitter array across the carrier. Also, a longer power rising period may be needed for the substrate to reach the same power peak P₂, and a longer power falling period may be similarly needed for the substrate to decrease to a lower laser power or to zero when the laser beam is not irradiated to the substrate.

It can be seen from the above examples that the power peak at the carrier or received by the substrate is generally in direct proportion to a magnitude of the laser power, but the period to reach the power peak is in reverse proportion to a speed of the laser emitter array relative to the carrier. In practical applications, the operator or user may apply different configurations to the laser assisted bonding device such that the laser beam irradiated to the substrate can generate a controllable power profile for the solder material on the substrate.

In some embodiments, the laser assisted bonding device may include a temperature sensor for detecting a temperature of the substrate which may be indicative of whether the substrate and the solder material thereon are undergoing a satisfactory heating or bonding process. Furthermore, the controller can be electrically coupled the temperature sensor to control the movement of the laser emitter array relative to the carrier and/or the laser beam based on the detected temperature. In this way, the laser beam for the bonding process can be dynamically adjusted. For example, if it is detected that the temperature of the substrate is a bit lower than a predetermined temperature lower limit, then an output power of each of the turned-on laser emitter units of the laser emitter array may be increased or more laser emitter units of the laser emitter array may be turned on to increase the overall output power of the laser emitter array, or the speed of the laser emitter array may be decreased to increase a period for irradiating the laser beam to the substrate. On the contrary, if it is detected that the temperature of the substrate is a bit higher than a predetermined temperature upper limit, then an output power of each of the active laser emitter units of the laser emitter array may be decreased or less laser emitter units of the laser emitter array may be turned on to decrease the overall output power of the laser emitter array, or the speed of the laser emitter array may be increased to decrease a period for irradiating the laser beam to the substrate.

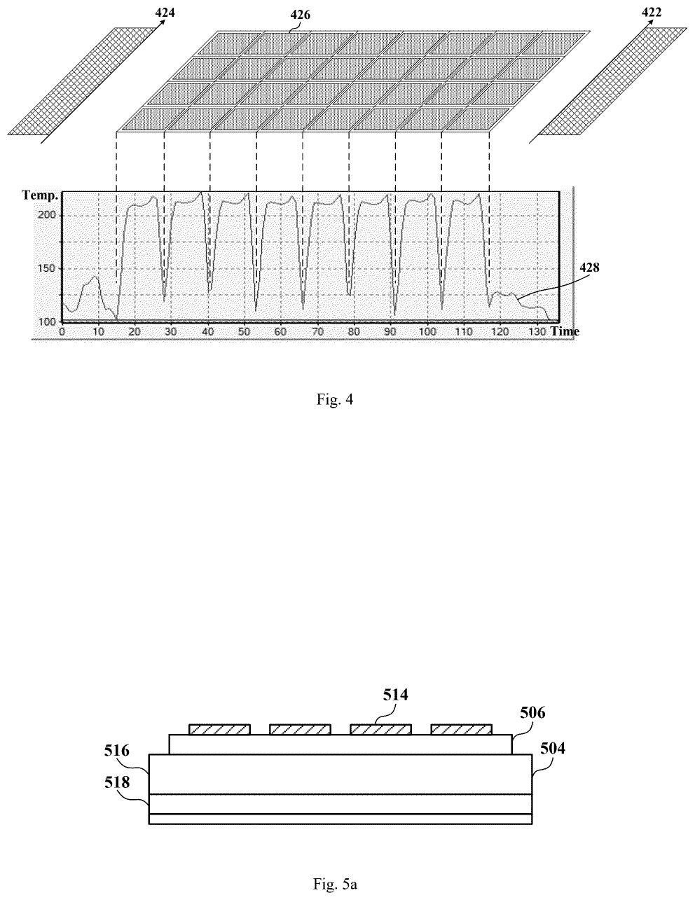

FIG. 4 illustrates a temperature measurement result of a laser beam emitted by a laser bonding device according to an embodiment of the present application.

As shown in FIG. 4, the laser beam may move from a start point 422 to an end point 424. During the movement of the laser beam, it may successively irradiate onto a plurality of substrates 426 that are placed on a carrier in the form of an array. At the same time, a temperature sensor (not shown) may move synchronically with the laser beam to detect respective temperatures of the substrate surfaces which are being irradiated by the laser beam. For example, the temperature sensor may be an infrared sensor, and it may be aligned with an edge of the laser beam when it reaches a top surface of the substrate. A temperature curve 428 generated by the temperature sensor shows that each substrate may undergo a similar heating process, with a temperature peak around 220 centi-degrees.

In some embodiments, the laser assisted bonding device may further include a laser power sensor or meter, which is used to detect an output power of the laser beam. For example, the laser power sensor may be positioned in front of the laser emitter array, e.g., somewhere between the laser emitter array and the carrier. In some embodiments, the power sensor may be positioned 5 cm to 10 cm away from the laser emitter array, floating above the carrier. The power sensor should have a field of view which can cover the laser beam emitted from the laser emitter array. For example, for a laser emitter array having a length of 4 cm, the power sensor may have a field of view with a diameter of 5 cm or greater. The laser power sensor may be a light intensity sensor. Preferably, the laser power sensor may move simultaneously with the laser emitter array to detect the laser beam. But in some alternative embodiments, the laser power sensor may include multiple sensor units distributed across the carrier, such that the laser beam can always be detected by at least a portion of the sensor units when the laser beam is moving. Furthermore, the controller may be further electrically coupled to the laser power sensor to control the movement of the laser emitter array relative to the carrier and/or the laser beam based on the detected laser power. For example, if it is detected that the laser power is lower than an expected power threshold, then the speed of the laser emitter array may be decreased; and if it is detected that the laser power is greater than the expected power threshold, then the speed of the laser emitter array may be increased. Furthermore, in some preferred embodiments, the laser power sensor may include multiple sensor units, each of which may be aligned with a split of the laser beam such that corresponding laser power measurements of the splits of the laser beam can be obtained from the respective sensor units. According to an exemplary measurement test, a variation of the laser power measurement is less than 3% for the entire laser beam, which shows a high uniformity.

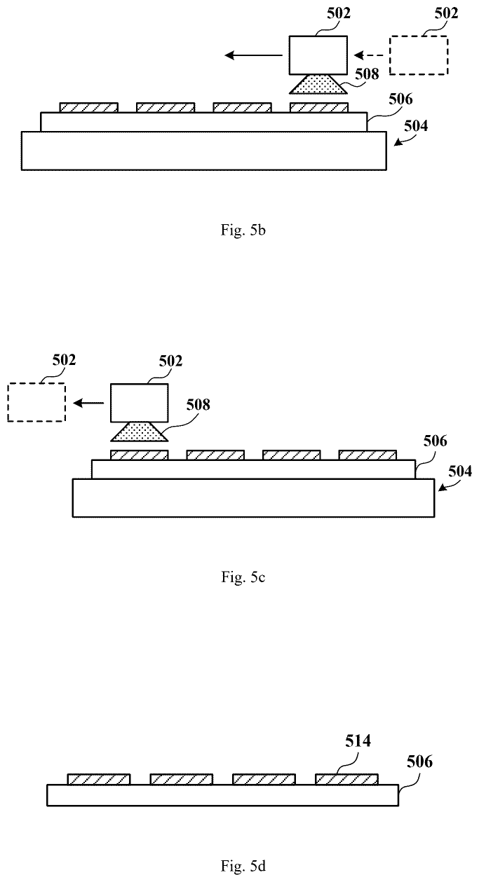

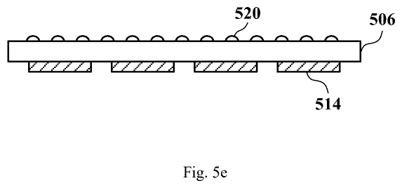

FIGS. 5a to 5e illustrate a bonding process implemented by a laser assisted bonding device according to an embodiment of the present application. For example, the bonding process may be implemented by the laser assisted bonding device 100 shown in FIG. 1a.

As shown in FIG. 5a, a substrate 506 may be placed on a carrier 504. It can be appreciated that in some examples, more than one substrates 506 may be placed on the carrier 504 at the same time such that the substrates 506 can be processed sequentially in a batch. One or more electronic components 514 such as semiconductor chips or dice may be disposed on the substrate 506 via a solder material (not shown), which are to be bonded onto the substrate 506. The carrier 504 may include a vacuum plate 516 for receiving the substrate 506 and applying a vacuum pressure to the substrate 506. For example, the vacuum plate 516 may be in fluid connection with a vacuum source via a pipeline, to receive the vacuum pressure. In this way, the substrate 506 may be firmly fixed to the carrier 504 to avoid undesired movement. In some embodiments, the carrier 504 may perform certain pre-processing such as pre-heating for the substrate 506. Accordingly, the carrier 504 may further include a heater 518 disposed below the vacuum plate 516 and for heating the substrate 506. The pre-heating of the substrate 506 can increase the temperature of the substrate 506 to a value close to but lower than a melting temperature of the solder material. As such, a smaller amount of laser energy or power may be required for the subsequent laser assisted bonding process.

Next, as shown in FIG. 5b, the carrier 504 carrying the substrate 506 may be moved to a position below a laser emitter array 502. In some embodiments, all the components of the carrier 504, including the vacuum plate and the heater, may be moved close to the laser emitter array 502. In some alternative embodiments, a portion of the carrier 504 such as the heater may not be moved with the substrate 506 and the vacuum plate. In other words, it is not required to heat the substrate 506 except the laser heating by the laser emitter array 502. The laser emitter array 502 may be aligned with an edge of the carrier 504 or the substrate 506. For example, in the embodiment shown in FIG. 5b, the laser emitter array 502 is substantially aligned with the right edge of the substrate or even more rightward (e.g., the entire laser beam does not irradiate onto the right edge of the substrate 506), so as to irradiate a laser beam 508 onto a rightmost electronic component or a rightmost column of electronic components on the substrate 506. Afterwards, the laser emitter array 502 may move horizontally towards the left edge of the substrate 506 till a leftmost electronic component or a leftmost column of electronic components on the substrate 506 or even more leftward (e.g., the entire laser beam passes the left edge of the substrate 506), as shown in FIG. 5c. In this way, all the electronic components on the substrate 506 and the solder materials under the electronic components can be heated by the laser beam 508. In some embodiments, the laser beam 508 may have an elongated beam shape. For example, the laser beam 508 may be of a width substantially equal to or greater than that of the substrate 506, and a controller of the laser assisted bonding device may control the movement of the laser emitter array 502 or the carrier 504 such that the laser beam 508 may traverse an entire length of the substrate 506 when the electronic component is bonded onto the substrate 506. It can be appreciated that the laser assisted bonding device may mainly rely on the laser energy from the laser emitter array 502 to reflow the solder material and bond the electronic component with the substrate. However, in some other embodiments, a mechanical pressure or force may be applied to the electronic component(s) to facilitate the bonding between the electronic component(s) and the substrate. For example, the laser emitter array may be placed inside a hollow frame (e.g., a rectangular frame with two bars mating with the laser beam in shape and two other bars connecting them) or a sleeve, which can move substantially synchronically with the laser emitter array. When the laser beam is irradiated to an area of the electronic component, the hollow frame or sleeve may be in contact with the electronic components and can press the electronic component against the substrate with a desired force or pressure.

Next, as shown in FIG. 5d, the substrate 506 may be removed from the carrier after the bonding process. Thus, the electronic components 514 are bonded onto the substrate 506 via the solder materials which have been transformed into solder bumps. Next, as shown in FIG. 5e, after the substrate 506 is flipped over with its back surface facing upward, it may be placed on a carrier such as the carrier 504 shown in FIGS. 5a to 5c. Then a solder material may be formed on the back surface of the substrate 506. The solder material can be reflowed, for example, using the laser emitter array (not shown) of the laser assisted bonding device in the embodiments of the present application, or any other suitable reflowing devices such as a heating device, and may then solidify into solder bumps 520 on the back surface of the substrate 506. The solder bumps 520 are used to electrically connect the semiconductor package with an external electronic device or system. It can be appreciated some other steps may be implemented on the substrate 506 to form a semiconductor package, such as an encapsulant molding process or an electromagnetic interference (EMI) shielding process, which may not be elaborated herein.

The discussion herein includes numerous illustrative figures that show various portions of a laser assisted bonding device. For illustrative clarity, such figures do not show all aspects of each exemplary method. Any of the example methods provided herein may share any or all characteristics with any or all other methods provided herein.

Various embodiments have been described herein with reference to the accompanying drawings. It will, however, be evident that various modifications and changes may be made thereto, and additional embodiments may be implemented, without departing from the broader scope of the invention as set forth in the claims that follow. Further, other embodiments will be apparent to those skilled in the art from consideration of the specification and practice of one or more embodiments of the invention disclosed herein. It is intended, therefore, that this application and the examples herein be considered as exemplary only, with a true scope and spirit of the invention being indicated by the following listing of exemplary claims.

1. A laser assisted bonding device, comprising:
a laser emitter array having a plurality of laser emitter units, wherein each of the laser emitter units is operable to be turned on or off independently from the other laser emitter units such that the laser emitter array is capable of emitting a laser beam with a controllable beam shape;
a carrier for placing a substrate which an electronic component is disposed on and to be bonded onto via a solder material;
a transfer mechanism for moving the laser emitter array relative to the carrier; and
a controller electronically coupled to the transfer mechanism to control a movement of the laser emitter array relative to the carrier, and electronically coupled to the laser emitter array to irradiate the laser beam to the substrate with a controllable power profile for the solder material when the electronic component is bonded onto the substrate via the solder material.

2. The laser assisted bonding device of claim 1, further comprising:
a temperature sensor for detecting a temperature of the substrate, and wherein the controller is further electronically coupled to the temperature sensor to control the movement of the laser emitter array relative to the carrier and/or the laser beam based on the detected temperature.

3. The laser assisted bonding device of claim 1, further comprising:
a laser power sensor for detecting an output power of the laser beam, and wherein the controller is further electronically coupled to the laser power sensor to control the movement of the laser emitter array relative to the carrier and/or the laser beam based on the detected laser power.

4. The laser assisted bonding device of claim 1, wherein the transfer mechanism comprises an actuator mechanically coupled to the laser emitter array.

5. The laser assisted bonding device of claim 1, wherein the transfer mechanism comprises a conveyor for supporting and moving the carrier.

6. The laser assisted bonding device of claim 1, wherein the controllable beam shape corresponds to a shape of the substrate.

7. The laser assisted bonding device of claim 1, wherein the controllable beam shape is of a width substantially equal to or greater than that of the substrate, and the controller is further configured to control the movement of the laser emitter array or the carrier such that the laser beam traverses across an entire length of the substrate when the electronic component is bonded onto the substrate.

8. The laser assisted bonding device of claim 1, where the carrier comprises:
a vacuum plate for receiving the substrate and applying a vacuum pressure to the substrate; and
a heater disposed below the vacuum plate and for heating the substrate.

9. A laser assisted bonding method, comprising:
placing a substrate on a carrier, wherein an electronic component is disposed on the substrate and to be bonded onto the substrate via a solder material;
irradiating to the carrier a laser beam with a controllable beam shape from a laser emitter array having a plurality of laser emitter units, wherein each of the laser emitter units is operable to be turned on or off independently from the other laser emitter units; and
moving the laser emitter array relative to the carrier such that the laser beam is irradiated to the substrate with a controllable power profile for the solder material when the electronic component is bonded onto the substrate via the solder material.

10. The laser assisted bonding method of claim 9, wherein the controllable beam shape corresponds to a shape of the substrate.

11. The laser assisted bonding method of claim 9, wherein the controllable beam shape is of a width substantially equal to or greater than that of the substrate, and moving the laser emitter array relative to the carrier further comprises traversing the laser beam across an entire length of the substrate when the electronic component is bonded onto the substrate.

12. The laser assisted bonding method of claim 9, further comprising: preheating the substrate before irradiating to the carrier a laser beam.
